(19) United States
(12) Patent Application Publication
(10) Pub. No.: US 2017/0228207 A1
(43) Pub. Date: Aug. 10, 2017

(54) SYSTEM AND METHOD FOR PROVIDING VISUAL FEEDBACK RELATED TO CROSS DEVICE GESTURES

(71) Applicant: NANOPORT TECHNOLOGY INC., Markham (CA)

(72) Inventors: Timothy Jing Yin SZETO, Markham (CA); David Michael Lopez Reyes, Toronto (CA)

(21) Appl. No.: 15/261,140

(22) Filed: Sep. 9, 2016

Related U.S. Application Data
(60) Provisional application No. 62/293,296, filed on Feb. 9, 2016.

(51) Int. Cl. G06F 3/14; G06F 3/0481; G06F 3/0488; G06F 3/041; G06F 3/01

(52) U.S. Cl. CPC G06F 3/1423; G06F 3/0412; G06F 3/016; G06F 3/04883; G06F 3/04817

(57) ABSTRACT

An electronic device includes a touch sensitive display and a processor in communication with the touch sensitive display. The device detects that a second electronic device is in a defined position proximate the electronic device and detects a touch gesture including a swipe tracing a path across the touch sensitive display between a first position proximate the second electronic device and a second position away from the second electronic device. In response to the detection of the touch gesture, regions of the displayed user interface are updated to include visual attributes of a user interface of the second electronic device.

### CROSS-REFERENCE TO RELATED APPLICATIONS

This application claims the benefit of U.S. Provisional Application No. 62/293,296, filed Feb. 9, 2016, the entire contents of which are hereby incorporated by reference.

### TECHNICAL FIELD

This relates to touch-based user interfaces, and more particularly to providing visual feedback for cross-device touch gestures.

### BACKGROUND

Gesture man-machine interfaces involve detection of defined motions made by a user. The various gestures each have an associated user-interface semantic.

Co-pending, co-owned U.S. patent application Ser. No. 15/175,814, the entire contents of which are hereby incorporated by reference, discloses interpreting cross-device gestures and providing access to resources. The gestures may be used to, for example, pair a device with an adjacent device, or to request specific resources of an adjacent device.

Visual feedback may be provided during gesture input to notify a user that a gesture is being recognized. For example, the above noted application discloses embodiments in which a button image, displayed on a touchscreen, tracks the gesture across devices.

Further methods of providing cross-device visual feedback are desirable.

### SUMMARY

The present application discloses novel ways of providing visual feedback during a cross-device device gesture. These may be used independently of, or in addition to, other methods of providing feedback.

In an aspect, there is provided a computer implemented method comprising at a first electronic device having a touch sensitive display, the touch sensitive display displaying a user interface detecting that a second electronic device is in a defined position proximate the first electronic device; detecting a touch gesture comprising a swipe tracing a path across the touch sensitive display between a first position proximate the second electronic device and a second position away from the second electronic device; and, in response to the detecting of the touch gesture, updating regions of the displayed user interface to include visual attributes of a user interface of the second electronic device.

Conveniently, in this way a user may be provided with visual feedback during gesture completion.

In an aspect, there is provided a non-transitory computer readable medium storing instructions that when executed by a processor of a first electronic device having a touch sensitive display, cause the device to detect that a second electronic device is in a defined position proximate the first electronic device; detect a touch gesture comprising a swipe tracing a path across the touch sensitive display between a first position proximate the second electronic device and a second position away from the second electronic device; and, during the detection of the touch gesture, update regions of the displayed user interface to include visual attributes of a user interface of the second electronic device.

In another aspect, there is provided a first electronic device comprising a touch sensitive display; a processor in communication with the touch sensitive display; a non-transitory computer-readable medium coupled to the processor and storing instructions that when executed by the processor cause the device to detect that a second electronic device is in a defined position proximate the first electronic device; detect a touch gesture comprising a swipe tracing a path across the touch sensitive display between a first position proximate the second electronic device and a second position away from the second electronic device; and, in response to the detection of the touch gesture, update regions of the displayed user interface to include visual attributes of a user interface of the second electronic device.

### BRIEF DESCRIPTION OF THE DRAWINGS

Embodiments are described in detail below, with reference to the following drawings.

FIG. 1 is a plan view of an electronic device illustrating the operating environment of an embodiment.

FIG. 2 is a high-level block diagram of the electronic device of FIG. 1, exemplary of an embodiment.

FIG. 3 illustrates the software organization of the electronic device of FIG. 1;

FIG. 4 is a plan view of the electronic device of FIG. 1 mechanically joined with a similar device, illustrating the operating environment of an embodiment;

FIG. 5 is a flow diagram illustrating the operation of the software of FIG. 3;

FIGS. 6A-6C are further views of the electronic devices of FIG. 4 illustrating visual feedback during an interaction gesture, exemplary of embodiments;

FIG. 7 is a further view of the electronic devices of FIG. 4 illustrating an alternate form of visual feedback during an interaction gesture, exemplary of embodiments;

FIG. 8 is a further view of the electronic devices of FIG. 4 illustrating another alternate form of visual feedback during an interaction gesture, exemplary of embodiments;

FIG. 9 is a further view of the electronic devices of FIG. 4 illustrating an example screen display for obtaining user confirmation of user intention;

FIG. 10 is a further view of the electronic devices of FIG. 4 illustrating a screen display further to confirmation of user intention;

FIG. 11 is a further view of the electronic devices of FIG. 4 illustrating cross-device display of an example application user interface;

FIGS. 12A-12C are further views of the electronic devices of FIG. 4 illustrating yet another alternate form of visual feedback for an interaction gesture, exemplary of embodiments;

FIGS. 13A-13C are further views of the electronic devices of FIG. 4 illustrating yet another alternate form of visual feedback for an interaction gesture, exemplary of embodiments;

FIG. 14 is a plan view of the electronic device of FIG. 1 mechanically connected to a non-touch sensitive electronic device, illustrating the operating environment of an embodiment; and

FIGS. 15A-15B are further views of the electronic devices of FIG. 14 illustrating visual feedback during an interaction gesture, exemplary of embodiments;

### DETAILED DESCRIPTION

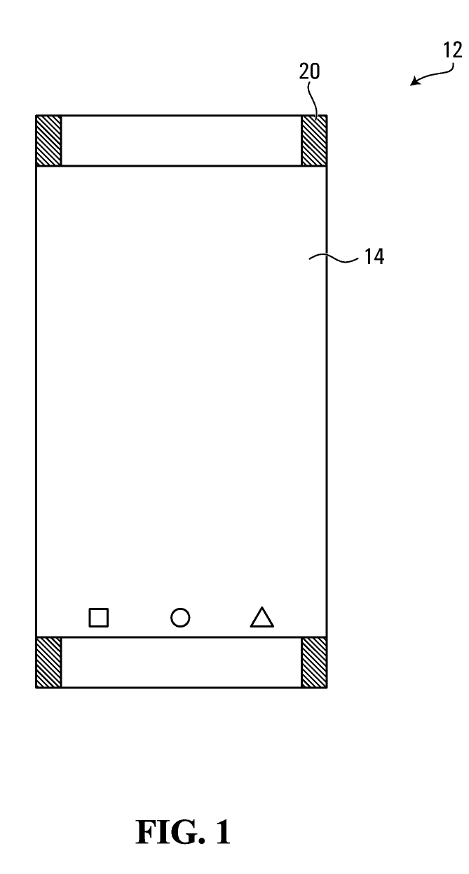

FIG. 1 is a plan view of an electronic device exemplary of an embodiment.

As illustrated, electronic device 12 includes a sensing surface in the form of a touch screen display 14 and includes mechanical connectors 20 for mechanically interconnecting one or more proximate devices.

Electronic device 12 is illustrated as a smartphone, however this is by no means limiting. Instead, as will become apparent, electronic device 12 may be any suitable computing device such as, for example, a smartphone, a tablet, a smart appliance, a peripheral device, etc.

Touch screen display 14 may be, for example, a capacitive touch display, a resistive touch display, etc. Touch screen display 14 may include a display element and a touch sensing element integrated as a single component. Alternatively, touch screen display 14 may include suitably arranged separate display and touch components. Touch screen display 14 may be adapted for sensing a single touch at once, or alternatively, multiple touches simultaneously. Touch screen display 14 may sense touch by, for example, a finger, a stylus, or the like.

As illustrated, magnetic connectors 20 of electronic device 12 permit electronic device 12 to be mechanically coupled to other suitable devices. An example of a possible magnetic connector is described in International Patent Application Publication No. WO 2015/070321 and U.S. Pat. No. 9,312,633. Each connector 20 offers a mechanical coupling function and, optionally, provide an electrical connection to a mechanically interconnected device. For example, a USB 2.0/3.0 bus may be established through the electrical connection.

Additionally or alternatively, electronic device 12 may have non-magnetic connectors for mechanical and/or electrical coupling with other suitable devices.

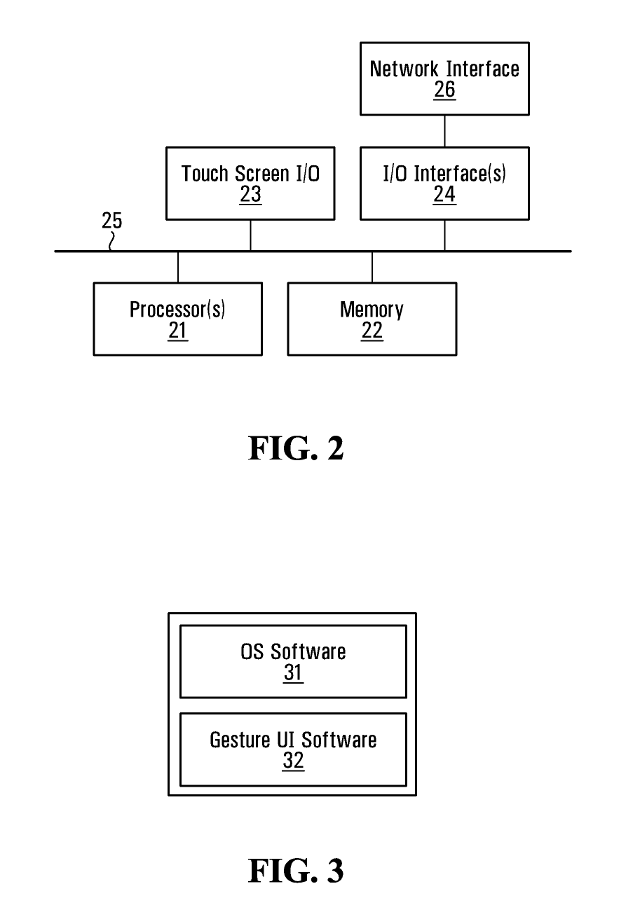

FIG. 2 is a simplified block diagram of the electronic device of FIG. 1, exemplary of an embodiment.

As illustrated, electronic device 12 includes one or more processor(s) 21, a memory 22, a touch screen I/O interface 23 and one or more I/O interfaces 24, all in communication over bus 25.

Processor(s) 21 may be one or more Intel x86, Intel x64, AMD x86-64, PowerPC, ARM processors or the like. In some embodiments, the one or more processor(s) 21 may be mobile processor(s) and/or may be optimized to minimize power consumption such as where, for example, electronic device 12 is battery operated.

Memory 22 may include random-access memory, read-only memory, or persistent storage memory such as a hard disk, a solid-state drive or the like. Read-only memory or persistent storage is a computer-readable medium. A computer-readable medium may be organized as a file system, controlled and administered by an operating system governing overall operation of the computing device.

Touch screen I/O interface 23 serves to interconnect the computing device with touch screen display 14. Touch screen I/O interface 23 is adapted to allow rendering images on touch screen display 14. Touch screen I/O interface 23 is also operable to sense touch interaction with one or more computer networks such as, for example, a local area network (LAN) or the Internet.

One or more I/O interfaces 24 may serve to interconnect the computing device with peripheral devices, such as for example, keyboards, mice, and the like. Optionally, network controller 26 may be accessed via the one or more I/O interfaces 24.

Software including instructions is executed by processor(s) 21 from a computer-readable medium. For example, software may be loaded into random-access memory from persistent storage of memory 22 or from one or more devices via I/O interfaces 24 for execution by one or more processors 21. As another example, software may be loaded and executed by one or more processors 21 directly from read-only memory.

FIG. 3 depicts a simplified organization of example software components stored within memory 22 of electronic device 12. As illustrated, these software components include operating system (OS) software 31 and gesture UI software 32.

OS software 31 may be, for example, Android OS, Apple iOS, Microsoft Windows, UNIX, Linux, Mac OSX, or the like. OS software 31 allows software 32 to access one or more processors 21, memory 22, touch screen I/O interface 23, and one or more I/O interfaces 24 of electronic device 12.

OS software 31 may provide an application programming interface (API) to allow for the generation and display of graphics on touch screen display 14. Likewise, OS software 31 may generate messages, callbacks, interrupts or other indications to application software representative of sensed input at touch screen I/O interface 23. Gesture UI software 32 adapts electronic device 12, in combination with OS software 31, to provide a gesture enabled UI (user interface).

OS software 31 may generate a user interface (UI) visible on touch screen display 14 that allows OS software 31 and application software (not shown) to present one or more visible user interfaces on touch screen display 14. OS software 31 may manage how applications are presented, how human-computer interactions are managed, and the like. To that end, OS software 31 may include a UI manager that controls the appearance and behaviour of the UI. UI manager may include a window manager, components for image composition, and the like. UI behaviour and appearance may be controlled by one or more parameters stored within memory 22. The UI manager may be controlled through an interface presented to a user of device 47, and/or an application program interface (API) to vary UI parameters—including for example, one or more of, the appearance of the visible user interface (e.g. screen background; font size; application appearance; icon appearance; etc.), notifications, and certain application and UI behaviours (e.g. screen behaviour). In some embodiments, the UI manager may comprise a theming engine that adapts the user interface including display thereof to correspond to a defined visual appearance. For example, the theming engine may utilize one of more packages of UI behavior configuration settings, visual elements, and the like that serve to group together elements associated with a particular visual appearance.

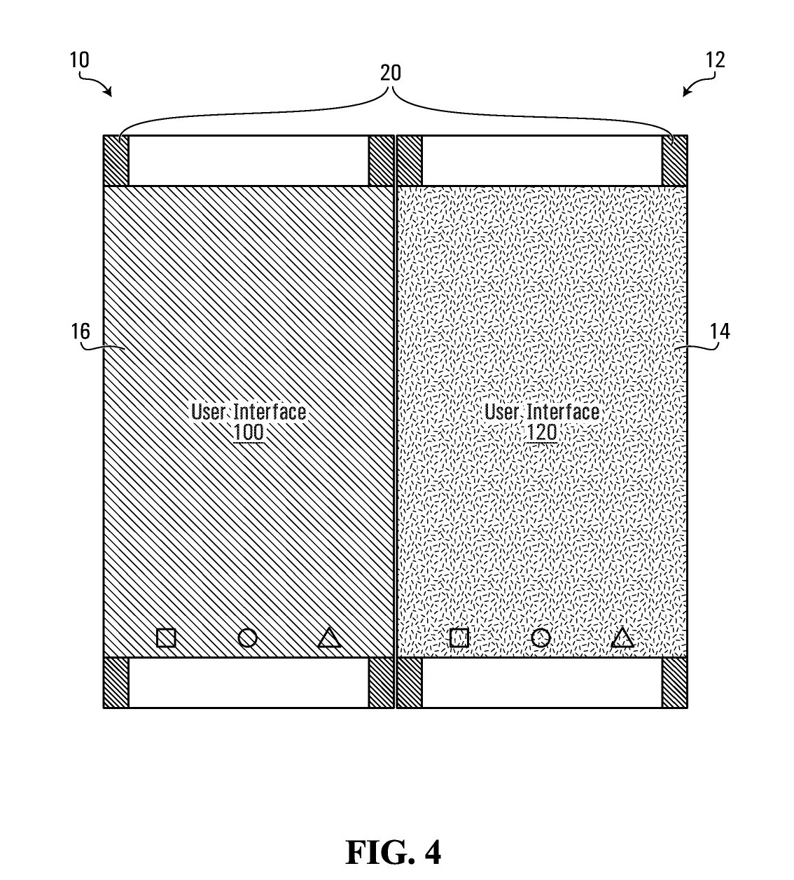

FIG. 4 is a plan view of electronic device 12 of FIG. 1 mechanically joined with a similar second electronic device 10, illustrating the operating environment of an embodiment;

Second electronic device 10 is similar or identical to electronic device 12, and includes hardware and software components as detailed above. As will be appreciated, second electronic device 10 need not be identical to electronic device 12, but may include functional components allowing device 12 to interact with device 10, as described herein. Second electronic device includes magnetic connectors 20 and a touch screen display 16.

As illustrated, electronic device 12 and second electronic device 10 may be mechanically coupled by way of magnetic connectors 20. As noted above, magnetic connectors may optionally offer an electronic connection.

Optionally, electronic device 12 and second electronic device 10 may communicate wirelessly, in which case connectors 20 need not, but still may, establish an electrical connection. Wireless communication may be, for example, by way of an 802.11x connection or, additionally or alternatively, using another technology such as, for example, Zigbee™, Bluetooth™, TransferJet™, or the like.

Electronic device 12 and second electronic device 10 each display a respective user interface. In particular, electronic device 10 displays a visible user interface 100 on touch screen 16. Similarly, electronic device 12 displays visible user interface 120 on touch screen 14.

As illustrated in FIG. 4, user interface 100 and user interface 120 may differ in visual appearance. For example, user interface 100 and user interface 120 may have a different wallpaper, background color, color scheme, design motif, design language, etc. As will be appreciated, such differences may arise from user preferences or customizations. Additionally or alternatively, such differences may also arise due to differences between the systems, such as, for example, different operating systems or different operating system versions executing on the devices.

In other embodiments, user interface 100 and user interface 120 may be similar or identical in appearance. Additionally or alternatively, user interface 100 and user interface 120 may offer similar or varied functionality.

In some embodiments, differences between user interface 100 and user interface 120 may result from or may be represented as different theme packages such as described above.

Once the two devices are connected by way of connectors 20, a user may interface a cross-device request by inputting a gesture that begins on touchscreen 16, proximate an edge of device 10, and extends across touch screen 14 towards a far edge of device 10. Of course, this is merely exemplary and a cross-device gesture could be performed in the opposite direction (i.e. from device 10 to device 12). In some embodiments, a cross-device gesture may begin on touch screen 16 before extending across touch screen 14 (or vice-versa).

In some embodiments, the direction of the gesture may itself at least partially identify the meaning of the gesture. For example, the direction of the cross-device gesture may dictate relative assignment of devices as master and slave in a master-slave relationship. For example, a cross-device gesture from device 12 to device 10 may indicate a user intention for device 10 to gain control resources of device 12, and allow device 10 to act as a master device 12. For example, device 10 may as a host to device 12 so that device 10 can utilize the display of device 12 so that the display elements of touchscreens 14 and 16 can be “stitched” (i.e. treated as a single display) for use by applications executing at one or both of device 10 and device 12.

As a cross-device gesture is detected, visual feedback may be provided as, for example, detailed herein. Conveniently, in this way, a user may understand that the gesture is being detected across devices (e.g. devices 12, 10). Additionally, the visual feedback may provide an indication as to the effect of the gesture. Conveniently, such visual feedback may yield a more intuitive user interface.

As will become apparent, visual feedback may include causing the user interface (or attributes of it) of one device to appear to propagate to the other device. For example, the look of user interface 100 may appear to propagate to touch screen 14 of device 12, replacing all or a portion of user interface 120. This may be accomplished by appropriate API calls to or configuration of, for example, a UI manager as described above.

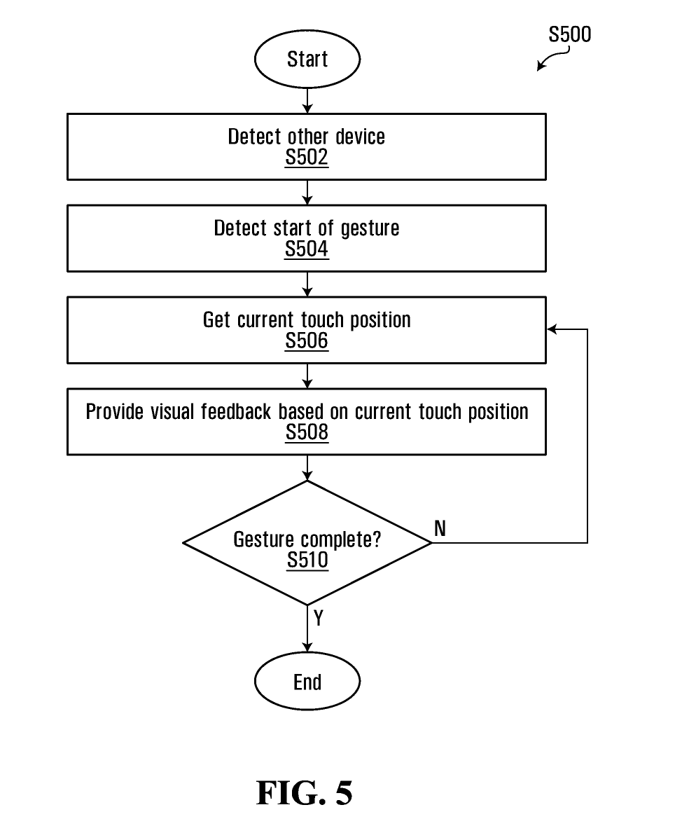

The operation of exemplary gesture UI software 32 is described with reference to the flowchart of FIG. 5. Blocks S500 and onward are performed by one or more processor(s) 21 executing software 32 at electronic device 12.

At block S502, processor(s) 21 detect that another device is connected. For example, in some embodiments, processor(s) 21 may receive an indication such as, for example, over bus 25 that another electronic device, such as second electronic device 10, is mechanically connected to electronic device 12 by way of mechanical connectors 20. For example, processor(s) 21 of device 12 may also determine the relative spatial relationships of the interconnected device. For example, in some embodiments, processor(s) 21 may receive an indication such as, for example, over bus 25 that another electronic device, such as second electronic device 10, is mechanically connected to electronic device 12 by way of mechanical connectors 20. Methods of detecting a connection state may be utilized such as, for example, as disclosed in above-noted U.S. Provisional Patent Application No. 62/327,826.

Additionally, a communications link may be established between electronic device 12 and the connected device such as via magnetic connectors 20 as discussed above. Additionally or alternatively, a wireless communications link may be established such as is discussed above.

At block S504, the start of a swipe gesture is detected originating at a region of touch screen display 14 of electronic device 12 proximate the other connected electronic device 10.

A swipe gesture may be detected as a first detection of a touch caused by an implement such as a finger, stylus, or the like touching down on touch screen 14. The gesture may continue, without lifting the implement, with the implement pulled across touch screen 14 in contact therewith, thereby tracing a path across touch screen 14 before being lifted off touch screen 14 at a second point, the lift off may also be part of the gesture—and detected. Processor(s) 21 may receive indications of all of these events such as, for example, over bus 25 from touch screen I/O interface 23. In some embodiments, multiple indications may be received or generated corresponding to each event. For example, a gesture may result in a series of touch events, each of which may be detected, and the collection of touch events, where appropriate, may be interpreted as a gesture. Multiple touch events may result in the generation of a message indicative of the gesture.

Alternatively, the swipe gesture may start with contact outside the touch sensitive area of the display such as for example, on the screen of the other connected device (e.g. device 10) or on a bezel of electronic device 12. In such cases, processor(s) 21 of device 12 may not receive any indication of the implement touching down and may only receive indication of the implement being pulled across touch screen 14 of device 12. Alternatively, an indication may be received that a touchdown occurred at an appropriate position along the extreme edge of touch screen 14 of device 12.

Additionally or alternatively, the swipe gesture may end with contact outside the touch sensitive area of the display such as for example on a bezel of electronic display 12. In such cases, processor(s) 21 may not receive any indication of the implement lifting off and may only receive indication of the implement being pulled across touch screen 14. Alternatively, an indication may be received that a lift off occurred at an appropriate position along the extreme edge of touch screen 14.

In some embodiments, electronic device 12 may receive an indication such as, for example, by way of the communication link of a first portion of the gesture detected by the other electronic device 10. The communication may, for example be a message passed along any electrical or other communication interconnection between devices 10 and 12. Optionally, electronic device 12 may perform steps to ensure that the portion of the gesture performed/sensed on it complements the portion of the gesture performed on the other electronic device 10. For example, software may be executed to ensure that the portions are spatially aligned such as in, for example, a single gesture spanning the two devices. For example, if electronic device 12 is coupled to second electronic device 10, the devices may communicate to determine whether a single gesture spans touch screen display 14 of device 12 and touch screen display 16 of device 10.

Processor(s) 21 may receive indications of all of these events such as, for example, over bus 25 from touch screen I/O interface 23. In some embodiments, multiple indications may be received or generated corresponding to each event.

At block S506, the current touch position on display 16 during the touch gesture is displayed. In some embodiments, this may involve periodic receipt of a touch position such as for example via touch screen I/O interface 23. Alternatively, one or more processors 21 may periodically poll touch screen I/O interface 23 for an updated touch position.

At block S508, visual feedback is provided to the user by updating attributes of user interface 120 based on the current touch position so that regions touched along the gesture resemble a user interface of the other electronic device. For example, if electronic device 12 is coupled to second electronic device 10, regions of user interface 120 may be updated to resemble user interface 100. For example, an application executing on device 12 may expand in window size as the gesture is inputted. This application on device 12 would be drawn to mimic the user interface of device 10, possibly based on UI assets received on device 12, by for example including visual features (e.g., background, colour, font, wallpaper, etc.) of the user interface of device 10.

As will become apparent, in some embodiments once regions of user interface 100 are updated to resemble the user interface of an interconnected device, the appearance of these regions may be maintained in that state at least until the completion of the detection of the gesture.

Device 12 may update user interface 120 based on configuration parameters of user interface 100. For example, configuration parameters may be received via a wired connection such as, for example, via an electrical connection established over connectors 20. Additionally, or alternatively configuration parameters may be received via a wireless connection. For example, configuration parameters may be received by a wireless connection as may be established with, for example, device 10 as described above.

User interface configuration parameters may be received from device 10. Additionally or alternatively, some or all of the configuration parameters may be obtained from a remote server, such as for example, based on a lookup using a characteristic of device 10 such as, for example, a device identifier. This may allow device 12 to obtain the parameters from a trusted server before a trusted communication channel has been established between devices 10/12. For example, a server could transmit the configuration parameters of a user interface of device 10 to device 12 or permit access by device 12 thereto upon receiving verification that device 10 and 12 are connected. For example, device 10 could communicate (directly or indirectly) with the server to indicate that it should communicate with device 12 regarding UI assets corresponding to device 10.

User interface configuration parameters may include graphic images (e.g. wall paper, backgrounds, or other graphic elements), colour schemes, icons, fonts, etc. In some embodiments, device 12 may receive an image for display. For example, device 12 may receive an image in bitmap, jpeg, or other format corresponding to the current screen display of user interface 100. Additionally or alternatively, device 12 may receive a bitmap corresponding to a wallpaper (eg. background image) of user interface 100. Additionally or alternatively, UI assets may be or may comprise, for example, a theme package as described above.

Additionally or alternatively, device 12 may receive more complex graphic parameters. Device 12 may also receive instruction for rendering graphic assets. For example, device 12 could receive a description of a screen display using a description format such as for example portable document format (PDF), Display PostScript (DPS), Quartz 2D, Extensible Application Markup Language (XAML), HTML5, or similar. Such a description may be, for example, be parsed and used to modify the screen display by appropriate API calls to a UI manager. Additionally or alternatively, the description of the screen display may supplied as received to OS software 13 such as, for example, for processing by a window manager component of a UI manager as described above.

At block S510, a determination is made to assess if the gesture is completed. A gesture may be considered complete if, for example, it has passed a pre-defined threshold such as disclosed in, for example, above noted co-pending application Ser. No. 15/175,814. In another example, a gesture may be considered complete if it has entered a pre-defined trigger region.

If the gesture is not completed, control flow proceeds to block S506 so that further visual feedback may be provided. Alternatively, if the gesture is completed control flow may terminate at block S510.

As will become apparent, following completion of the process of FIG. 5, processing related to received gesture may continue.

As noted above, visual feedback is provided during the gesture by updating regions of user interface 120 based on the current touch position so that those regions resemble user interface 100.

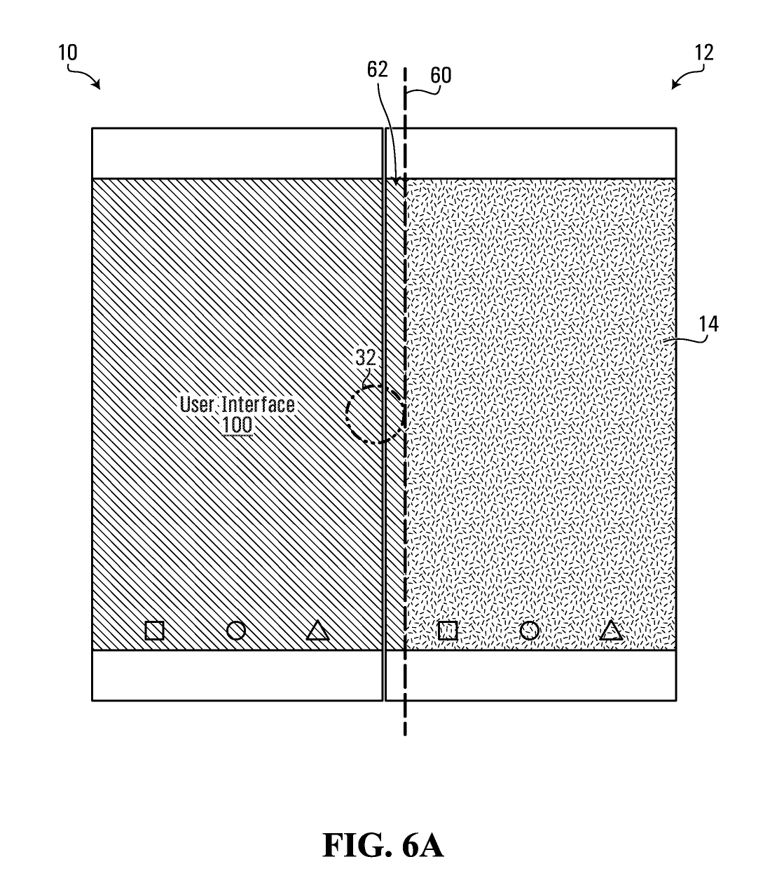

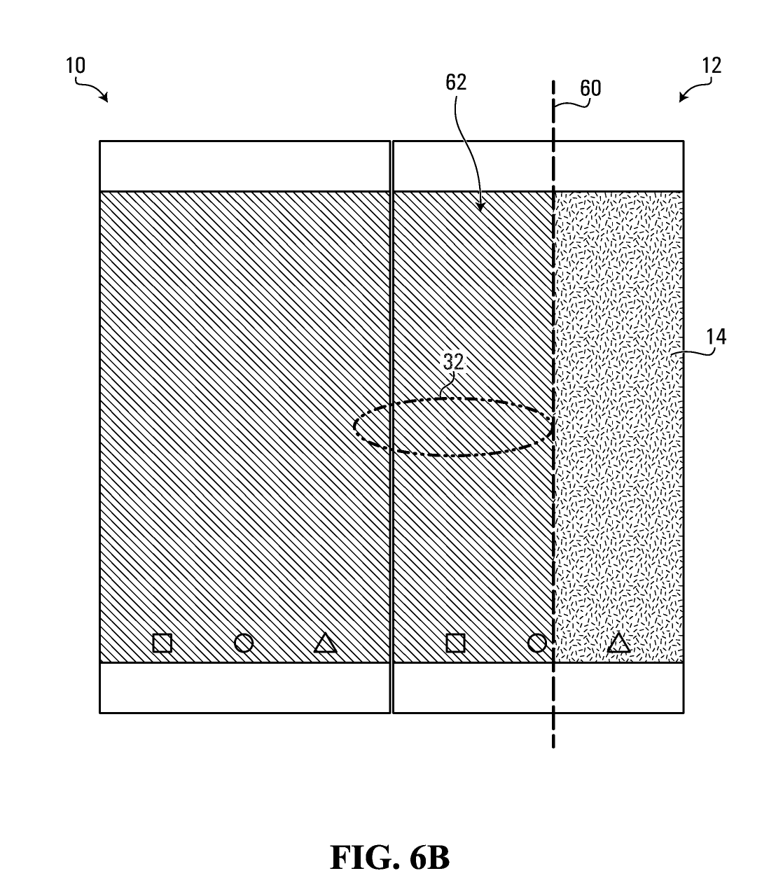

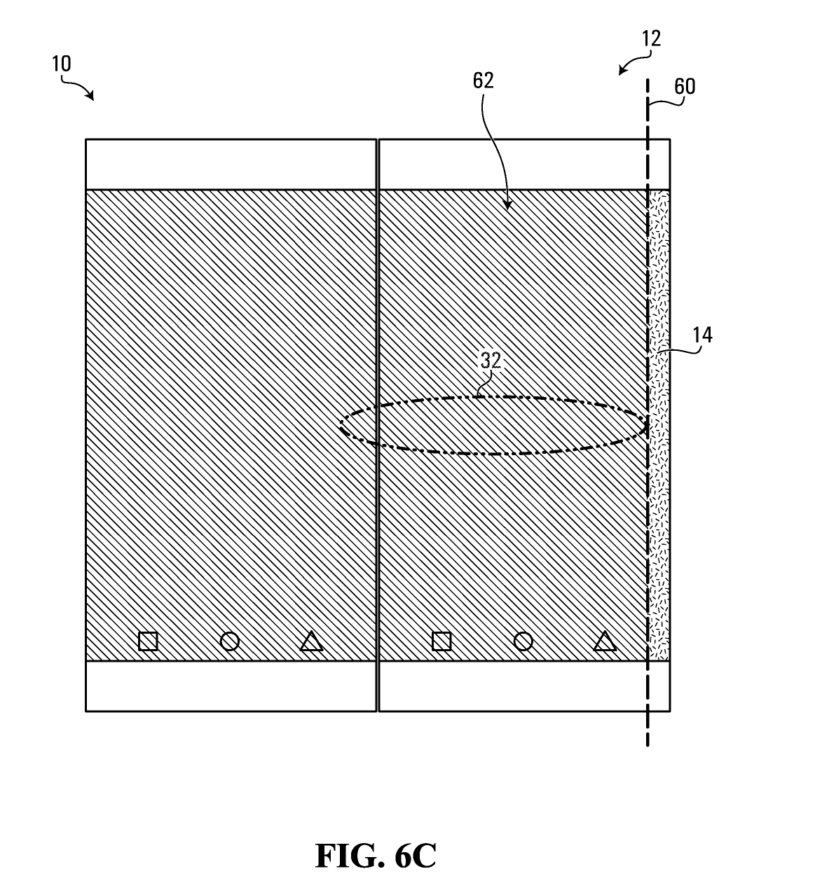

FIGS. 6A-6C are further views of the electronic devices of FIG. 4 illustrating example visual feedback during an interaction gesture, exemplary of embodiments;

FIGS. 6A, 6B, and 6C illustrate how the display on device 12 is updated in response to a gesture 32 as it sweeps across touchscreen 14 at successive times t₁, t₂, and t₃, respectively.

As illustrated, as gesture 32 traverses across touchscreen 14, a region 62 of touch screen 14 is updated to corresponding to user interface 100 of device 10. Notably region 62 of screen spans the entire vertical extent of touchscreen 14 and is bounded on the left by the edge of touchscreen 14 most proximate device 10. On the right, region 62 is bounded by a straight line boundary 60 (denoted as a stippled line for the purposes of illustration only) parallel to the aforementioned edge. Straight-line boundary 60 is positioned according to the extent of travel of gesture 32 across touchscreen 14. Put differently, region 62, mathematically speaking, is the locus of points having a perpendicular distance from the aforementioned edge of touchscreen 14 that is less than or equal to the perpendicular distance from that edge of the rightmost extent of gesture 32. As gesture 32 sweeps rightward, the rightmost extent of gesture 32 is, put differently, the current touch point of gesture 32 at a given time.

Of course, a straight-line boundary between region 62 and the rest of touchscreen 14 is in no way required. For example, region 62 could have a different shape and correspondingly boundary 60 may take a different shape.

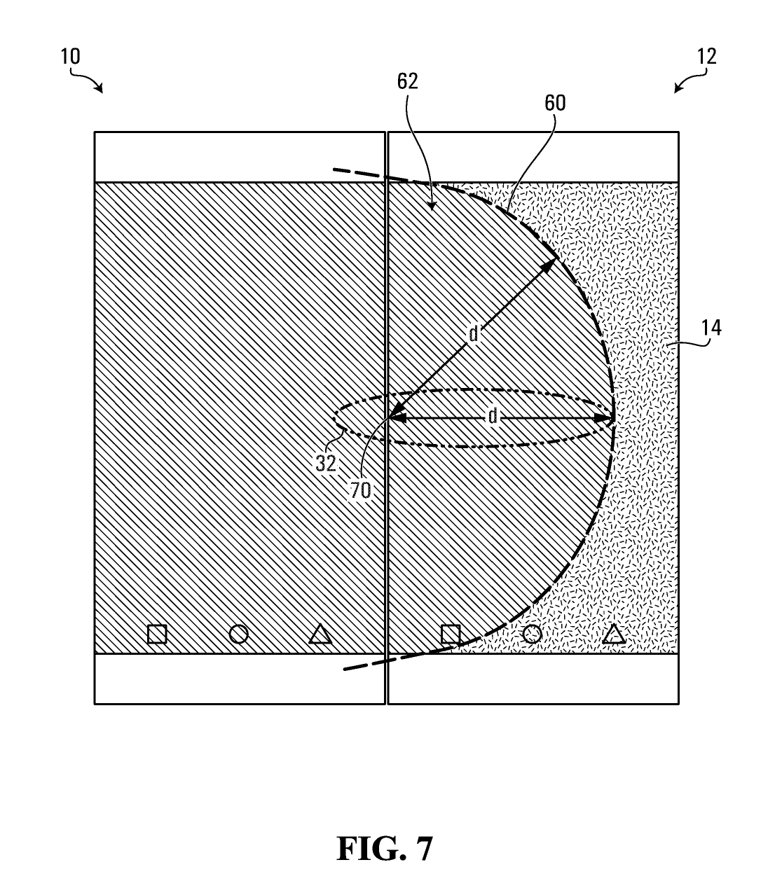

FIG. 7 is a further view of the electronic devices of FIG. 4 illustrating an alternate form of visual feedback during an interaction gesture, exemplary of embodiments;

In FIG. 7, boundary 60 is a segment of a circle again positioned according to the extent of travel of gesture 32 across touchscreen 14.

In other words in FIG. 7, mathematically speaking, region 62 is the locus of points having a distance from a start point 70 of gesture 32 less than or equal to the distance, denoted as d, between point 70 and the current touch point of gesture 32 at a given time step. Conveniently, in this way, region 62 may appear to radiate from the point of a touch implement such as, for example, a user's finger or stylus, as the user performs gesture 32.

Other definitions of region 62 are possible. For example, in some embodiments, region 62 may not span the vertical extent of touchscreen 14.

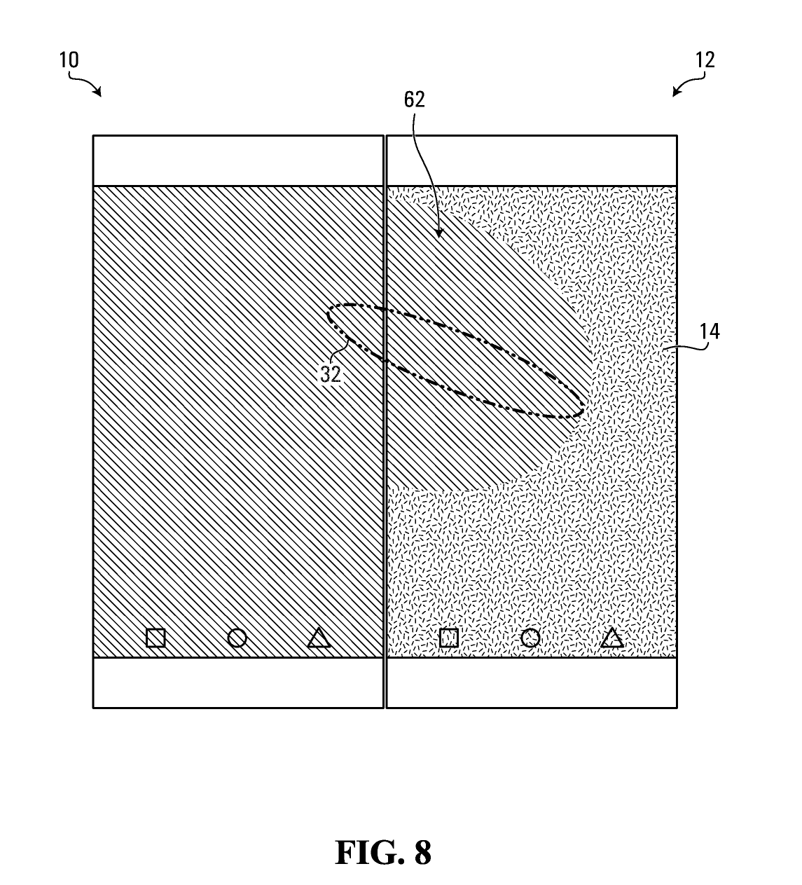

FIG. 8 is a further view of the electronic devices of FIG. 4 illustrating another alternate form of visual feedback during an interaction gesture, exemplary of embodiments;

As illustrated, region 62 may expand in a direction that follows a vector of a user's gesture 32. The extent of such a region 62 may be defined, for example, by stretching a defined shape to encompass the path of gesture 32 or otherwise along the vector of gesture 32.

Following the completion of gesture 32, device 12 processes the request. Optionally device 12 may ask the user to confirm the request.

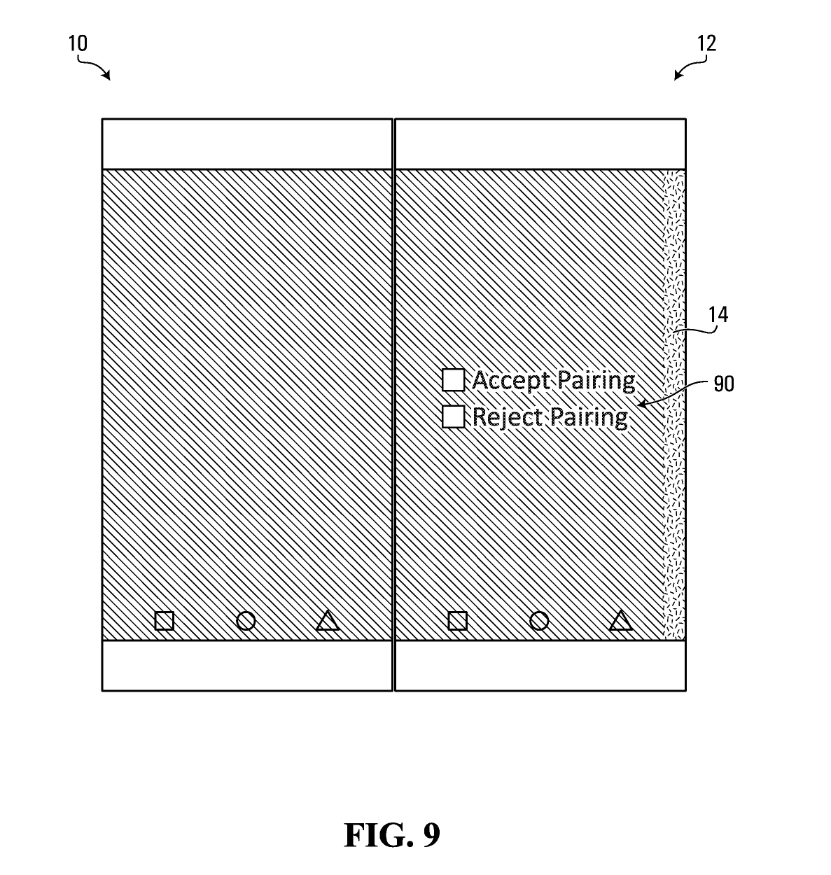

FIG. 9 is a further view of the electronic devices of FIG. 4 illustrating an example screen display for obtaining user confirmation of user intention.

As illustrated, a user may be presented with user interface display 90 having options to accept or reject the device pairing.

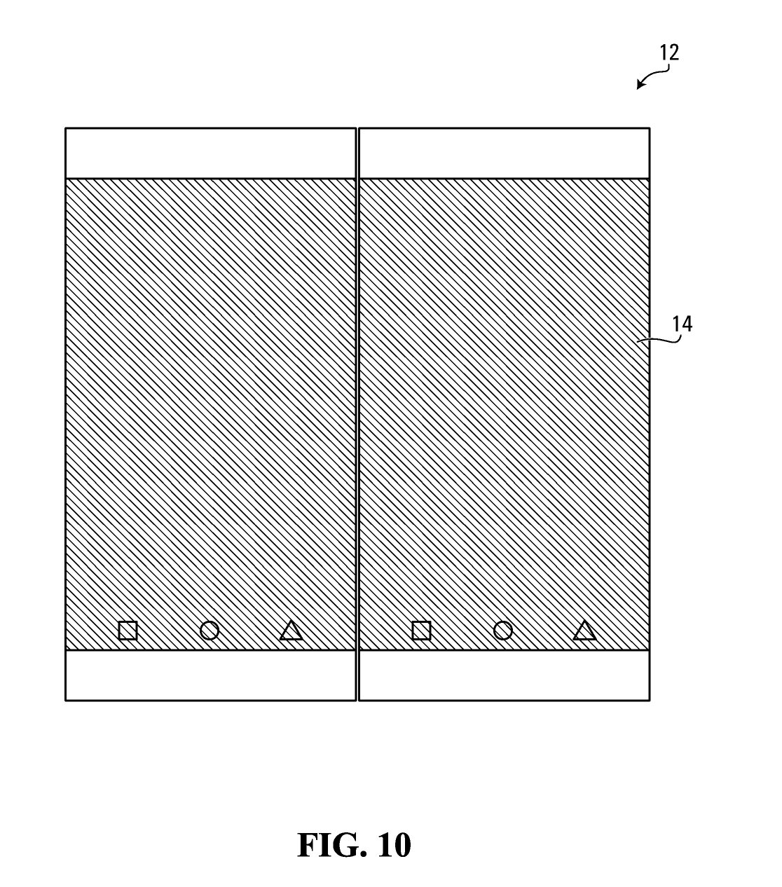

Following completion of the gesture and, if provided, an approval of the confirmation, device 12 may grant the request from device 10. As shown in FIG. 10, if the requested is granted, device 12 may adapt the entirety of the display on touchscreen 14 to resemble user interface 100.

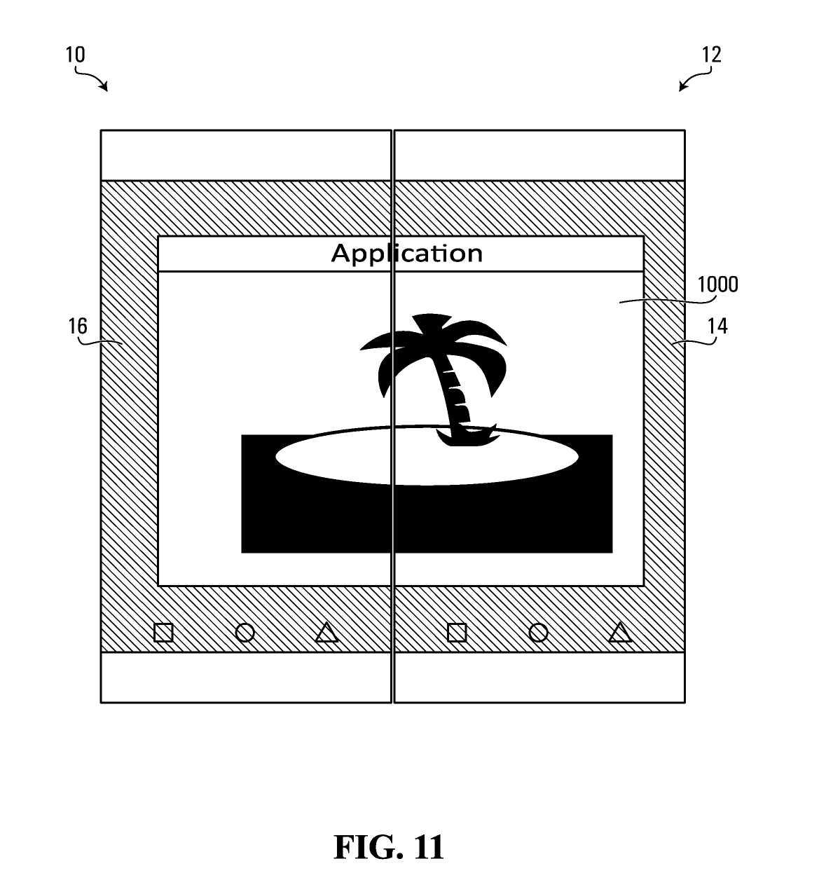

Subsequently, device 10 can utilize the granted resources of device 12. For example, if device 10 has been granted access to touchscreen display 14, device 10 may cause device 12 to display some or all of an interface 1100 of an application executing at device 10 as shown in FIG. 11. Notably, in doing so, device 12 continues to adapt the display of touch screen 14 to display user interface elements resembling user interface 100 of device 10.

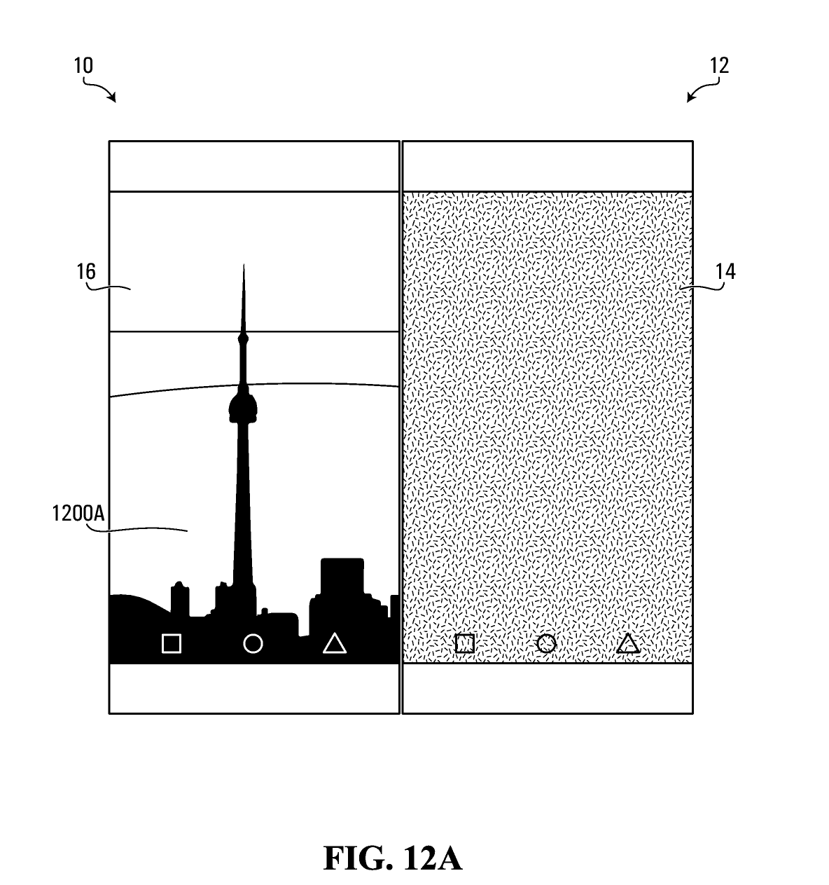

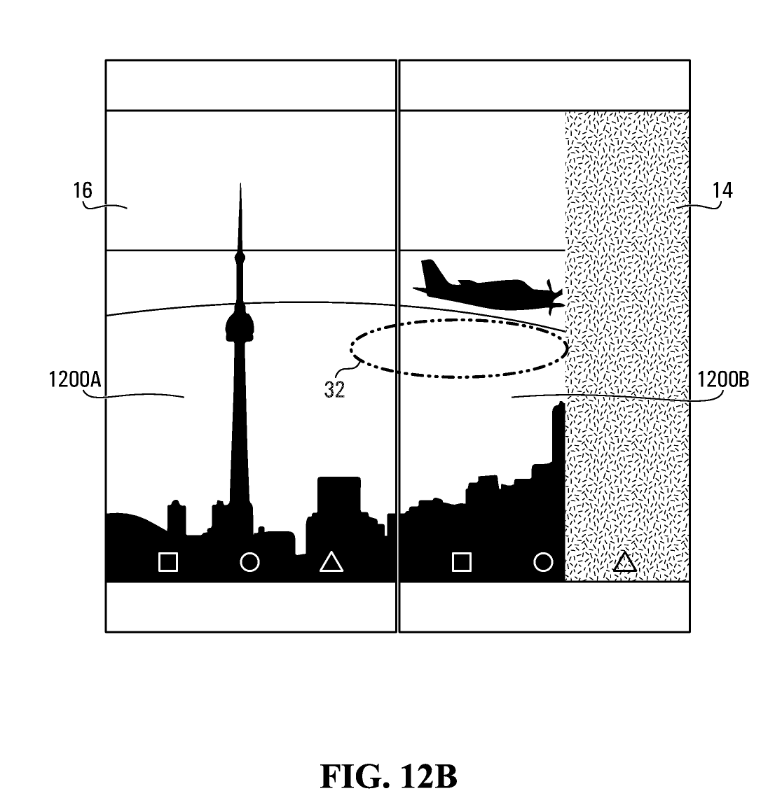

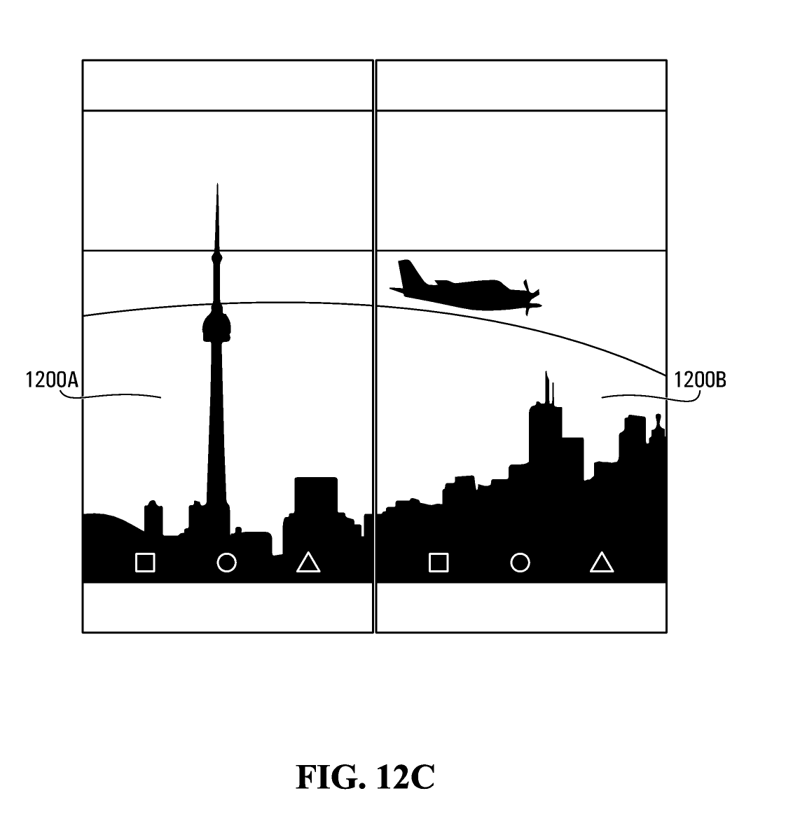

FIGS. 12A-12C are further views of the electronic devices of FIG. 4 illustrating yet another alternate form of visual feedback in response to a gesture 32 as it sweeps across touchscreen 14 at successive times t₁, t₂, and t₃, respectively.

As shown in FIG. 12A, user interface 100 displayed on touchscreen 16 of device 10 includes a graphic 1200A. Graphic 1200A may be, for example, a wallpaper (i.e. a background image). In some embodiments graphic 1200A may also be drawn behind other UI elements (not shown) that may occlude all or a portion of graphic 1200A.

Notably displayed graphic portion 1200A is only a portion of a much larger bitmap.

As shown in FIGS. 12B and 12C, as gesture 32 sweeps across touchscreen 14, visual feedback on the gesture may be provided by displaying a further 1200B of the larger bitmap. Notably, as illustrated, graphics portions 1200A and 1200B correspond so that the displayed portion of the bitmap appears to extend across touchscreen displays 16 and 14. As gesture 32 extends across display 14, more of the bitmap is revealed in portion 1200B.

As illustrated, portion 1200B has, in effect, a straight-line akin to that of FIGS. 6A-6C. This is illustrative only and is by no means limiting. For example, the displayed portion of the bitmap could be of a different shape such as in the different example shapes of region 62 described above.

In some embodiments, the entire bitmap may be displayed as graphic portion 1200A prior to the start of the cross-device gesture and may be stretched across touchscreen displays 16 and 14 as the gesture is performed by the user. In such embodiments, both device 10 and device 12 update their respective displays to show the stretching.

In some embodiments, dynamic content may be displayed in lieu of a bitmap. For example, the bitmap may be replaced with a video.

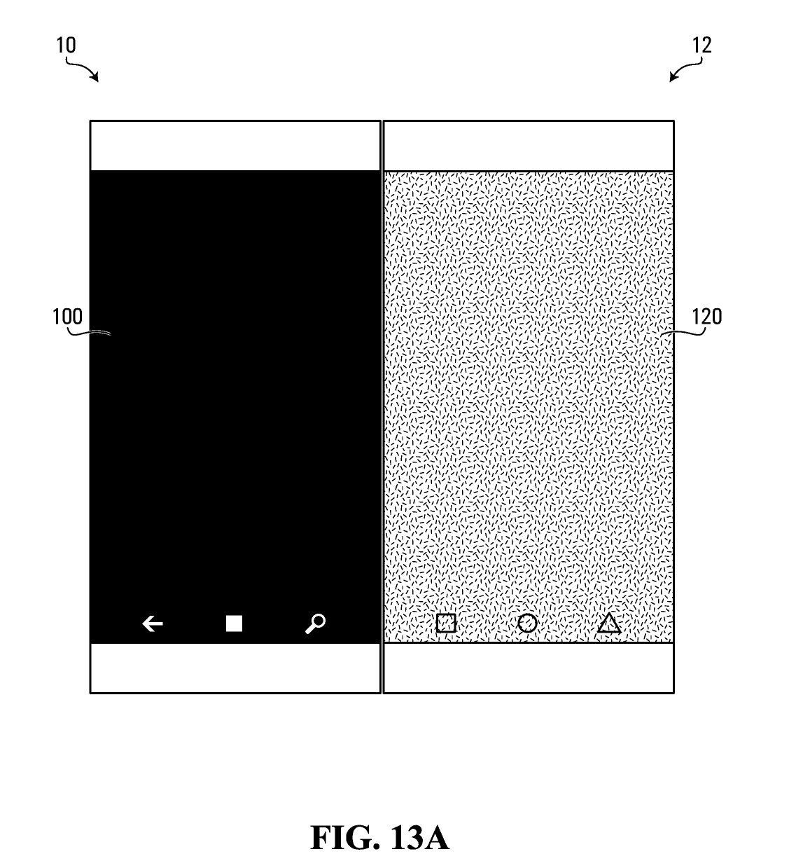

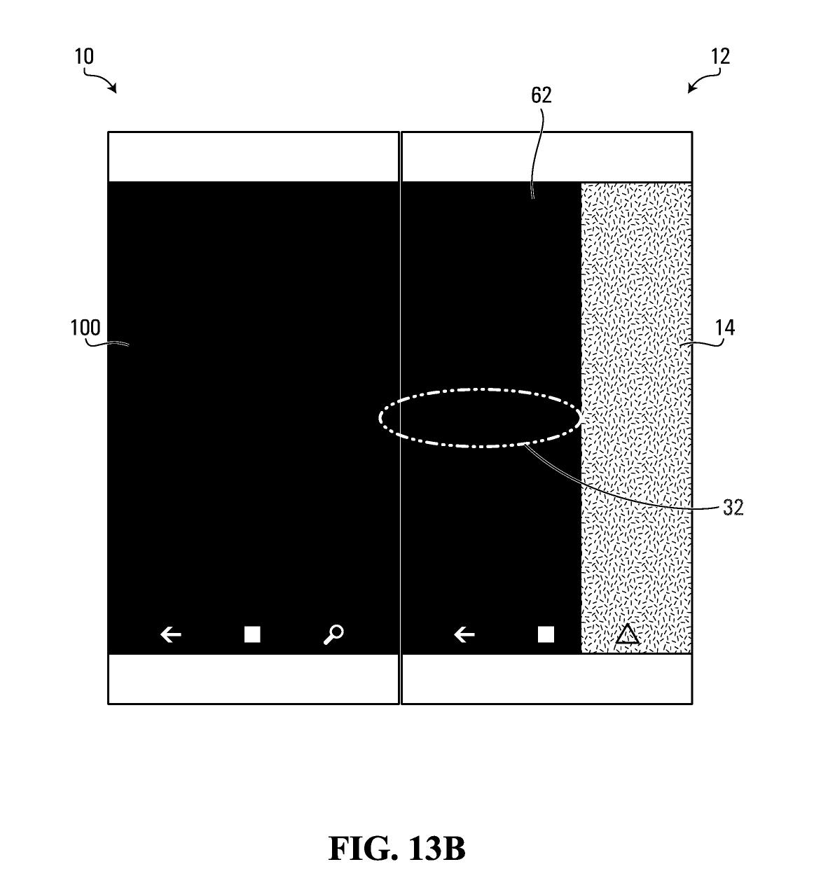

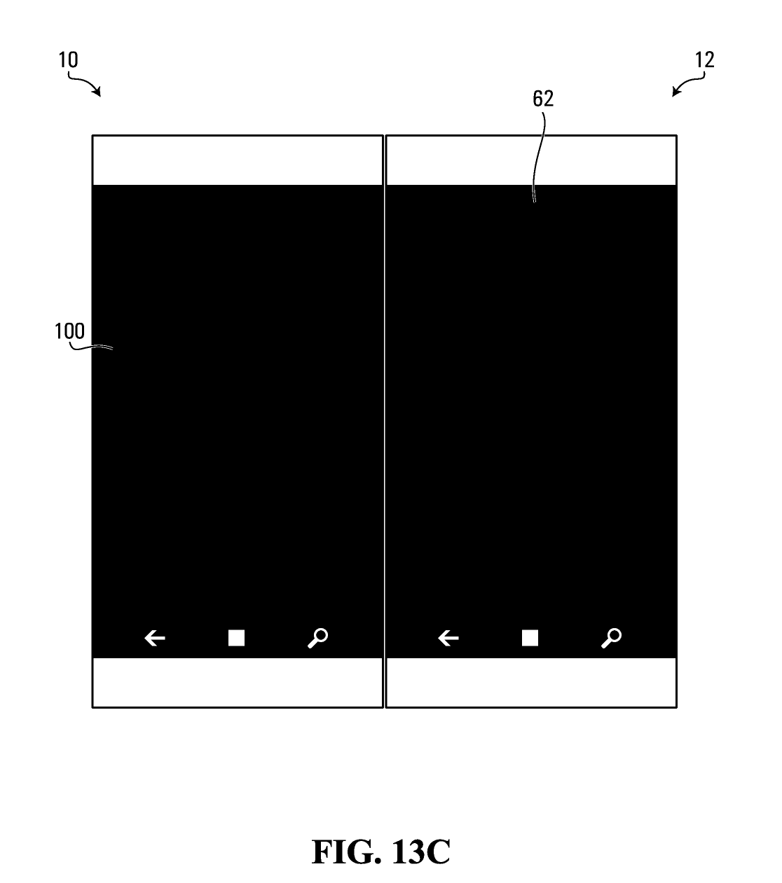

Devices 10 and 12 may each run different operating systems or different operating systems versions. Accordingly, as in shown in FIG. 13A, user interface 100 and user interface 120 may be for a first and second operating system respectively.

FIGS. 13A-13B are further views of the electronic devices of FIG. 4, exemplary of embodiments, illustrating visual feedback during an interaction gesture involving electronic devices 10 and 12, running different operating system software. In particular, FIGS. 13A-13B illustrate visual feedback in response to a gesture 32 as it sweeps across touchscreen 14 at successive times t₁ and t₂, respectively. As illustrated, as gesture 32 extends across touchscreen 14, device 12 adapts a region 62 of its display to resemble the operating system of device 10

FIG. 14 shows a portion of electronic device 12 mechanically connected to a non-touch sensitive electronic device 10′.

Device 10′ is equipped with one or more magnetic connectors 20.

The user interface of device 10′ may be very limited. As illustrated, device 10′ includes a button 1400. Button 1400 may be, for example, a mechanical switch, a capacitive button, etc. Button 1400 may be used to indicate the start of a gesture.

As illustrated, device 12 has been connected with device 10′ by way their respective magnetic connectors 20.

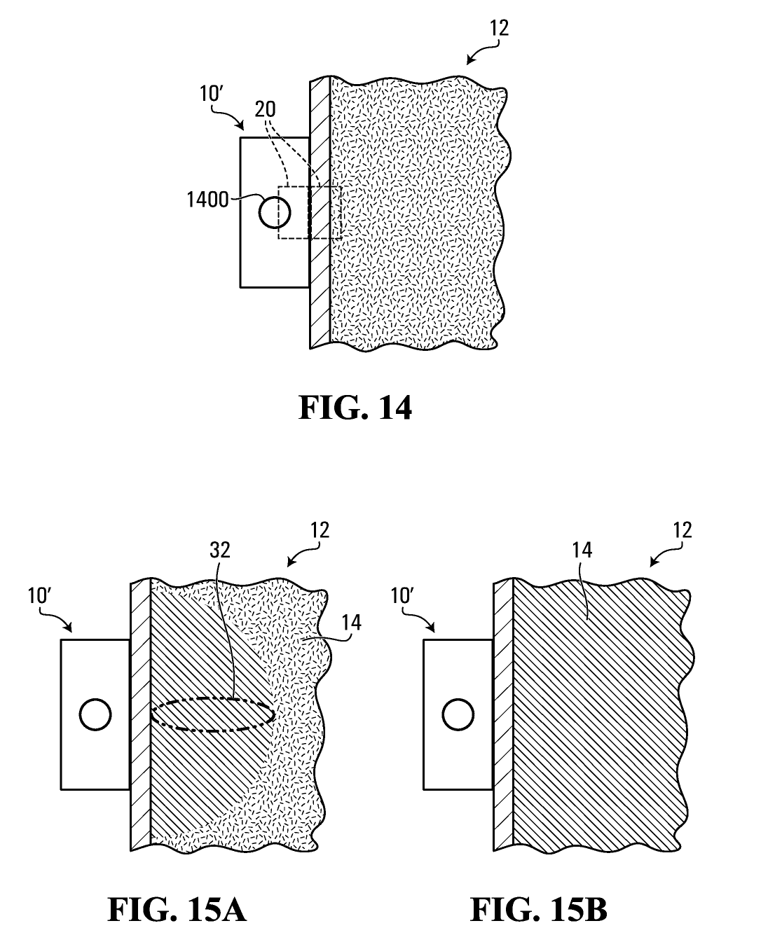

FIGS. 15A and 15B show device 12 adapting its display to visually mimic attributes of a user interface of device 10′ as a gesture 32 is extended across touchscreen 14 of device 12.

Notably, the above embodiments have been described with devices, such as the requesting and responding device, devices having displays, and devices not equipped with a touch sensitive region being in particular relative positions. Of course, this is by way of illustration only and is in no way limiting. The devices may, for example, be rotated into various positions. Similarly, gestures need not proceed left-to-right only or even only left-to-right or right-to-left. For example, where the devices are placed with one above the other, gestures may be, in effect, vertical rather than horizontal.

Of course, the above described embodiments are intended to be illustrative only and in no way limiting. The described embodiments are susceptible to many modifications of form, arrangement of parts, details and order of operation. The invention is intended to encompass all such modification within its scope, as defined by the claims.

What is claimed is:

1. A computer implemented method comprising:
at a first electronic device having a touch sensitive display, said touch sensitive display displaying a user interface:
detecting that a second electronic device is in a defined position proximate said first electronic device;
detecting a touch gesture comprising a swipe tracing a path across said touch sensitive display between a first position proximate said second electronic device and a second position away from said second electronic device; and,
in response to said detecting of said touch gesture, updating regions of said displayed user interface to include visual attributes of a user interface of said second electronic device.

2. The method of claim 1 further comprising receiving, at said second electronic device, one or more assets of said user interface of said user interface of said second electronic device and wherein said displayed user interface is updated based on said assets.

3. The method of claim 2, wherein said assets are received from said second electronic device.

4. The method of claim 2, wherein said assets are received from a server remote from said first and second electronic devices.

5. The method of claim 2, wherein said assets comprise at least one of graphics, icons, or fonts.

6. The method of claim 2, wherein said assets comprise a bitmap.

7. The method of claim 6, wherein said bitmap is a wallpaper of said user interface of said second electronic device.

8. The method of claim 2, wherein said assets comprise instructions for rendering one or more graphical assets.

9. The method of claim 1 wherein said displayed user interface is for a first operating system and said user interface of said second electronic device is for a second operating system and wherein said updating regions of said displayed user interface to include visual attributes of a user interface of said second electronic device comprises updating said regions to resemble said second operating system.

10. The method of claim 1 wherein said regions are defined by successive touch positions of said gesture, each of said regions comprising all points on said display having a perpendicular distance from a straight edge of said touch sensitive display proximate said first position being less than or equal to the perpendicular distance from that edge to a current touch position during said touch gesture.

11. The method of claim 1 wherein said regions are defined by successive touch positions of said gesture, each of said regions comprising all points on said display having a distance from said first position being less than or equal to the distance from said first position to a current touch position during said touch gesture.

12. The method of claim 1, wherein said touch gesture is for indicating user intention to pair said first and second electronic devices.

13. The method of claim 12, further comprising pairing said first and second electronic devices.

14. The method of claim 12 further comprising receiving, at said first electronic device, a confirmation of user intention to pair said first and second electronic devices.

15. The method of claim 14, further comprising, upon receiving said confirmation, pairing said first and second electronic devices and updating the entirety of said displayed user interface to resemble said user interface of said second electronic device.

16. A non-transitory computer readable medium storing instructions that when executed by a processor of a first electronic device having a touch sensitive display, cause said device to:
detect that a second electronic device is in a defined position proximate said first electronic device;
detect a touch gesture comprising a swipe tracing a path across said touch sensitive display between a first position proximate said second electronic device and a second position away from said second electronic device; and,
during said detection of said touch gesture, update regions of said displayed user interface to include visual attributes of a user interface of said second electronic device.

17. A first electronic device comprising:
a touch sensitive display;
a processor in communication with said touch sensitive display;
a non-transitory computer-readable medium coupled to the processor and storing instructions that when executed by said processor cause said device to:
detect that a second electronic device is in a defined position proximate said first electronic device;
detect a touch gesture comprising a swipe tracing a path across said touch sensitive display between a first position proximate said second electronic device and a second position away from said second electronic device; and,
in response to said detection of said touch gesture, update regions of said displayed user interface to include visual attributes of a user interface of said second electronic device.
